(19) United States
(12) Patent Application Publication
(10) Pub. No.: US 2024/0353008 A1
(43) Pub. Date: Oct. 24, 2024

(54) SEAL STRUCTURE FOR IN-WHEEL ELECTRIC MOTOR DRIVE SYSTEM, AND IN-WHEEL ELECTRIC MOTOR DRIVE SYSTEM

(71) Applicant: Schaeffler Technologies AG & Co. KG, Herzogenaurach (DE)

(72) Inventors: Bin Zhang, Shanghai (CN); Jin Wang, Shanghai (CN); Xin Liu, Shanghai (CN); Ding Li, Su Zhou (CN)

(21) Appl. No.: 18/689,360

(22) PCT Filed: Sep. 6, 2021
(86) PCT No.: PCT/CN2021/116671

§ 371 Date: Mar. 5, 2024

(51) Int. Cl. F16J 15/447; B60K 7/00

(52) U.S. Cl. CPC F16J 15/447; B60K 7/0007

(57) ABSTRACT

A seal structure for an in-wheel electric motor drive system. The seal structure is used for forming a seal between a first sealed portion (90s) of an output shaft and a second sealed portion (10s) of a housing. The seal structure (1) comprises a dustproof ring (11) and a seal assembly (12). The dustproof ring (11) is used for being fixed to the first sealed portion (90s); the dustproof ring (11) extends radially outwards, so that the dustproof ring (11) and the second sealed portion (10s) form a labyrinth seal structure (1); the seal assembly (12) is used for being fixed to the second sealed portion (10s); and the seal assembly (12) is provided with a plurality of lips extending towards the first sealed portion (90s) and/or the dustproof ring (11), and is used for blocking the communication between the labyrinth seal structure (1) and the interior of an in-wheel electric motor drive system, thereby greatly reducing the probability of the lips of the seal assembly being damaged due to water freezing after same enters the position where the seal assembly is located. Further provided is an in-wheel electric motor drive system comprising the seal structure.

### CROSS-REFERENCE TO RELATED APPLICATION

The present application is the U.S. National Phase of PCT Patent Application Number PCT/CN2021/116671, filed on Sep. 6, 2021, the entire disclosure of which is incorporated by reference herein.

### TECHNICAL FIELD

The present application relates to the field of sealing, specifically to a seal structure used between an output shaft and a housing of an in-wheel electric motor drive system.

### BACKGROUND

In the prior art, a new energy vehicle such as an electric vehicle has a drive motor, a planetary gear reducer, a wheel bearing, a braking system and other parts integrated in the wheel space to form an in-wheel electric motor drive system, in which the drive motor can directly drive wheels.

FIG. 1A shows a structure of an in-wheel electric motor drive system of the prior art. As shown in FIG. 1A, the in-wheel electric motor drive system comprises a housing (comprising a housing body 10 and a housing cover 20), a drive motor 30, a rotor bracket 40, a seal structure 50, a radial bearing 60, a planetary gear reducer 70, a thrust bearing 80 and an output shaft (a flange shaft) 90 which are assembled together. The seal structure 50 is disposed between the housing body 10 and the output shaft 90 to seal the mounting space in the housing, thereby preventing foreign matter from entering the place where the planetary gear reducer 70 is located.

Specifically, as shown in FIG. 1B, the seal structure 50 is disposed between the portions of the housing body 10 and the output shaft 90 that are opposite to each other. Specifically, the seal structure 50 comprises a dustproof ring 501 and a seal assembly 502. The dustproof ring 501, which is fixed to the output shaft 90 to rotate with it, extends toward and has a gap with the housing body 10. The seal assembly 502, which is fixed to the housing body 10, has a dustproof lip 502p extending into the gap between the dustproof ring 501 and the housing body 10. Although the dustproof lip 502p can prevent foreign matter such as dust from entering the interior of the in-wheel electric motor drive system, snow water or cleaning water may still enter the dustproof lip 502p. In a low-temperature environment, this water could freeze the dustproof lip 502p and the dustproof ring 501 together. As such, if the output shaft 90 rotates relative to the housing when a vehicle comprising the above-mentioned in-wheel electric motor drive system runs, the dustproof lip 502p is more likely to be damaged.

### SUMMARY

The present application aims to address the deficiencies of the prior art as described above. An objective of the present application is to provide a new seal structure for an in-wheel electric motor drive system. The seal structure reduces the probability of a seal lip being damaged due to water freezing after same enters the seal structure, while forming a seal between a housing and an output shaft of the in-wheel electric motor drive system. Another objective of the present application is to provide an in-wheel electric motor drive system comprising the seal structure.

To achieve the above-mentioned objectives, the present disclosure adopts the following technical solutions.

The present application provides a seal structure for an in-wheel electric motor drive system, the seal structure being overall annular and used for forming a seal between a first sealed portion of an output shaft and a second sealed portion of a housing in the in-wheel electric motor drive system, wherein the first sealed portion and the second sealed portion are opposite to each other in a radial direction of the output shaft, and the second sealed portion is located radially outside the first sealed portion; and the seal structure comprises a dustproof ring and a seal assembly: the dustproof ring, which is used for being fixed to the first sealed portion, extends radially outwards, so that the dustproof ring extends beyond an inner peripheral surface of the second sealed portion; and the dustproof ring is further formed with a structure that is bent toward the second sealed portion, so that the dustproof ring and the second sealed portion overlap with each other while being spaced apart in an axial direction and the radial direction of the output shaft, thereby forming a labyrinth seal structure; the seal assembly, which is used for being fixed to the second sealed portion, is fully located between the first sealed portion and the second sealed portion; the seal assembly is provided with a plurality of lips extending toward the first sealed portion and/or the dustproof ring for blocking the communication between the labyrinth seal structure and the interior of the in-wheel electric motor drive system.

In an alternative solution, the dustproof ring comprises a first axial portion, a radial portion and a second axial portion that form a single piece; the first axial portion extends in the axial direction and is used for being fixed to the first sealed portion, the radial portion extends in the radial direction and is connected to the first axial portion and the second axial portion, and the second axial portion extends from the radial portion toward the second sealed portion in the axial direction.

In another alternative solution, a notch is formed on the radial outer side of the second sealed portion, and the second axial portion extends from the radial portion to the notch.

In another alternative solution, an outer peripheral surface of the dustproof ring is substantially flush with that of the second sealed portion; the outer peripheral surface of the dustproof ring is located radially inside that of the second sealed portion.

In another alternative solution, the seal assembly comprises a frame, a main lip and a radial elastic member; the main lip, which is attached to the frame, extends toward and contacts the first sealed portion; and the radial elastic member is nested in the main lip from the radial outer side of the main lip to apply an elastic force that keeps the main lip in contact with the first sealed portion.

In another alternative solution, at least a portion of the main lip extends obliquely in a direction away from the dustproof ring while extending toward the radial inner side.

In another alternative solution, the seal structure further comprises a first auxiliary lip and a second auxiliary lip attached to the frame; the first auxiliary lip and the second auxiliary lip are arranged apart in the radial direction, the first auxiliary lip extending from the frame toward and keeping in contact with the dustproof ring, the second auxiliary lip extending from the frame toward and keeping in contact with the dustproof ring.

In another alternative solution, at least a portion of the first auxiliary lip and of the second auxiliary lip extend obliquely toward the radial outer side while extending toward the dustproof ring.

In another alternative solution, the seal assembly further comprises a third auxiliary lip located radially outside relative to the first auxiliary lip and the second auxiliary lip; the third auxiliary lip, spaced apart from the first auxiliary lip and the second auxiliary lip, extends from the frame toward and has an axial gap with the dustproof ring.

In another alternative solution, the third auxiliary lip is configured to have a structure that is bent toward the radial outer side.

The present application further provides an in-wheel electric motor drive system comprising: an output shaft; a housing; and the seal structure for an in-wheel electric motor drive system according to any one of the preceding solutions, wherein the dustproof ring is fixed to the first sealed portion, and the seal assembly is fixed to the second sealed portion.

With the above-mentioned solutions, the present application provides a new seal structure for an in-wheel electric motor drive system and the in-wheel electric motor drive system comprising the same. The seal structure is overall annular and used for forming a seal between the first sealed portion of the output shaft and the second sealed portion of the housing in the in-wheel electric motor. The first sealed portion and the second sealed portion are opposite to each other in a radial direction of the output shaft, and the second sealed portion is located radially outside the first sealed portion. The seal structure comprises a dustproof ring and a seal assembly. The dustproof ring, which is used for being fixed to the first sealed portion, extends radially outwards, so that the dustproof ring extends beyond an inner peripheral surface of the second sealed portion. The dustproof ring is further formed with a structure that is bent toward the second sealed portion, so that the dustproof ring and the second sealed portion overlap with each other while being spaced apart in an axial direction and the radial direction of the output shaft, thereby forming a labyrinth seal structure. The seal assembly, which is used for being fixed to the second sealed portion, is fully located between the first sealed portion and the second sealed portion; the seal assembly is provided with a plurality of lips extending toward the first sealed portion and/or the dustproof ring for blocking the communication between the labyrinth seal structure and the interior of the in-wheel electric motor drive system.

With a labyrinth seal structure formed between the dustproof ring and the housing, the sealing performance of the seal structure of the present application is improved. Moreover, the seal assembly is fully located between the housing and the output shaft, and substantially isolated from external environment by the dustproof ring. It is not likely that a liquid such as water will enter the place where the seal assembly is located through the labyrinth seal structure. This greatly reduces the probability of the lips of the seal assembly being damaged due to water freezing after same enters the position where the seal assembly is located.

### BRIEF DESCRIPTION OF THE DRAWINGS

FIG. 1A is a sectional schematic diagram of an in-wheel electric motor drive system of the prior art.

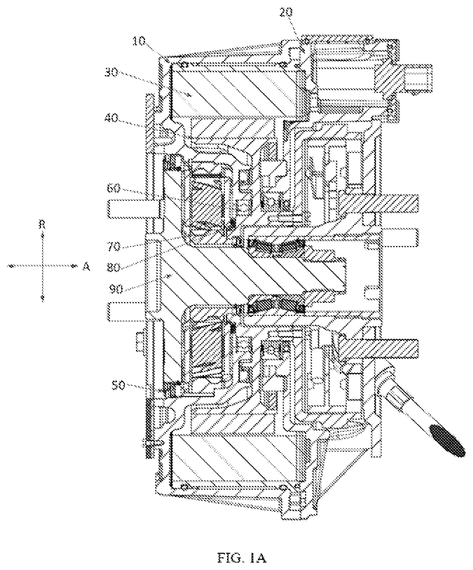

FIG. 1B is an enlarged sectional schematic diagram of a partial structure of the in-wheel electric motor drive system in FIG. 1A, with a section line omitted.

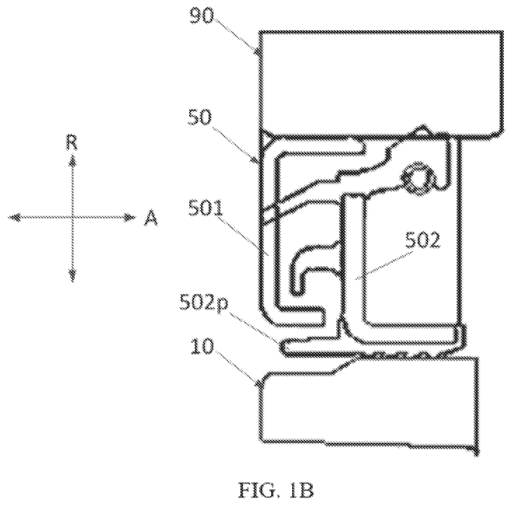

FIG. 2 is an enlarged sectional schematic diagram of a partial structure of the in-wheel electric motor drive system in FIG. 1A comprising a seal structure according to an embodiment of the present application, with a section line omitted.

### DETAILED DESCRIPTION

Specific embodiments of the present application will be described below in detail with reference to the drawings of the Specification. It should be understood that the purpose of these specific descriptions is merely to teach those skilled in the art how to implement the present application, and are neither intended to be exhaustive of all possible modes of the present application nor to limit the scope of the present application.

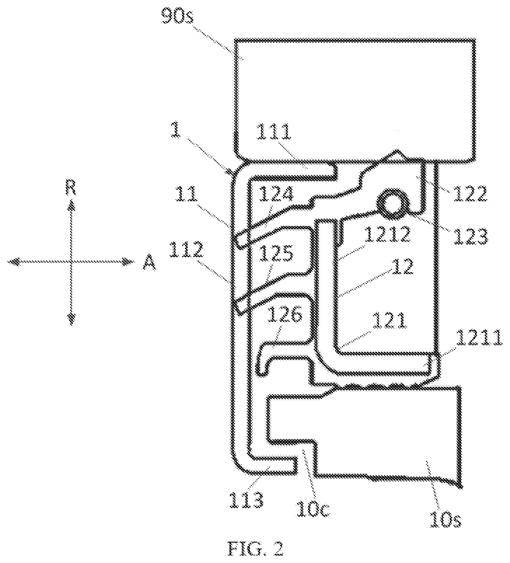

In the Specification, unless otherwise specified, “axial direction” and “radial direction” refer to an axial direction and a radial direction of an output shaft of an in-wheel electric motor drive system, respectively. An axial side refers to the left side and the other axial side refers to the right side, as shown in FIG. 2.

In the specification, unless otherwise specified, “lip” refers to a seal lip made of elastic material for sealing.

As shown in FIG. 2, a seal structure 1 for an in-wheel electric motor drive system according to an embodiment of the present application is overall annular and used for forming a seal between a first sealed portion 90s of an output shaft and a second sealed portion 10s of a housing in the in-wheel electric motor drive system. The first sealed portion 90s and the second sealed portion 10s are opposite to each other in a radial direction R, and the second sealed portion 10s is located radially outside the first sealed portion 90s. The seal structure 1, which is mounted coaxially with the output shaft, comprises a dustproof ring 11 and a seal assembly 12. The dustproof ring 11 is located adjacent the axial side (axial outer side) compared with the seal assembly 12. In other words, the seal assembly 12 is disposed closer to the interior of the in-wheel electric motor drive system.

In this embodiment, the dustproof ring 11 may be made of metal. The dustproof ring 11 is fixed to the first sealed portion 90s, so that it can rotate with the first sealed portion 90s of the output shaft. The dustproof ring 11 extends radially outwards from the first sealed portion 90s beyond an inner peripheral surface of the second sealed portion 10s. In addition, there remains a gap between the dustproof ring 11 and the second sealed portion 10s.

Specifically, the dustproof ring 11 comprises a first axial portion 111, a radial portion 112 and a second axial portion 113 that form a single piece. The first axial portion 111 extends in the axial direction A and is fixed to the first sealed portion 90s, for example, by interference fit. The radial portion 112 extends in the radial direction R and is connected to the first axial portion 111 and the second axial portion 113. A radial inner end of the radial portion 112 is connected to an axial side end of the first axial portion 111, and a radial outer end of the radial portion 112 is connected to an axial side end of the second axial portion 113. The second axial portion 113 extends from the radial portion 112 in (generally along) the axial direction A toward the second sealed portion 10s (i.e. the other axial side), until a notch 10c formed on the radial outer side of the second sealed portion 10s. In addition, in the embodiment, an outer peripheral surface of the dustproof ring 11 is substantially flush with that of the second sealed portion 10s to prevent the dustproof ring 11 from extending too far radially outwards and interfering with other components.

Therefore, the dustproof ring 11 is formed with a structure that is bent toward the second sealed portion 10s. Specifically, a portion (a radial outer side portion) of the radial portion 112 of the dustproof ring 11 and the second axial portion 113 overlap with the second sealed portion 10s in the radial direction R (that is, spanning the same height in the radial direction, or blocking each other when viewed in the axial direction); the second axial portion 113 of the dustproof ring 11 further overlaps with the second sealed portion 10s in the axial direction A (that is, locating at the same position in the axial direction, or blocking each other when viewed in the radial direction). As a result, the dustproof ring 11 and the second sealed portion 10s overlap with each other while being spaced apart in the axial direction A and the radial direction R, thereby forming a labyrinth seal structure. This can prevent foreign matter such as dust and water from entering the space between the dustproof ring 11 and the seal assembly 12.

In the embodiment, the seal assembly 12 is fully located between the first sealed portion 90s and the second sealed portion 10s. The seal assembly 12, which is fixed to the second sealed portion 10s, is used for blocking the communication between the above-mentioned labyrinth seal structure and the interior of the in-wheel electric motor drive system. Specifically, the seal assembly 12 comprises a frame 121, a main lip 122, a radial elastic member 123, a first auxiliary lip 124, a second auxiliary lip 125 and a third auxiliary lip 126.

The frame 121, which may be made of metal, comprises a frame axial portion 1211 and a frame radial portion 1212 that form a single piece. The frame axial portion 1211 extends in the axial direction A. The frame radial portion 1212 is connected to an axial side end of the frame axial portion 1211 and extends radially inwards in the radial direction R to a position with a predetermined gap from the first sealed portion 90s.

The main lip 122 is made of elastic material such as rubber, and fixed to a radial inner side end of the frame radial portion 1212, for example, by vulcanized attachment. The main lip 122 extends toward and contacts the first sealed portion 90s. Specifically, the main lip 122 extends obliquely in a direction away from the dustproof ring 11 while extending radially inwards so as to contact the first sealed portion 90s. The radial elastic member 123 is nested in the main lip 122 from the radial outer side of the main lip 122. The radial elastic member 123 can apply to the main lip 122 an elastic force toward the radial inner side that keeps the main lip 122 in contact with the first sealed portion 90s. An example of the radial elastic member 123 is a coil spring in an overall circular shape.

The first auxiliary lip 124 and the second auxiliary lip 125 are made of elastic material such as rubber. The first auxiliary lip 124 is fixed to a radial inner side end of the frame radial portion 1212, for example, by vulcanized attachment. The second auxiliary lip 125 is fixed to a radial central portion of the frame radial portion 1212, for example, by vulcanized attachment. The first auxiliary lip 124 and the second auxiliary lip 125 are arranged apart in the radial direction R, and the first auxiliary lip 124 is located radially inside the second auxiliary lip 125. The first auxiliary lip 124 and the second auxiliary lip 125 extend substantially in the same manner. A portion of the first auxiliary lip 124 and of the second auxiliary lip 125 extend obliquely toward the radial outer side while extending toward the radial portion 112 of the dustproof ring 11. Therefore, the first auxiliary lip 124 extends from the frame 121 toward and keeps in contact with the radial portion 112 of the dustproof ring 11, and the second auxiliary lip 125 extends from the frame 121 toward and keeps in contact with the radial portion 112 of the dustproof ring 11.

The third auxiliary lip 126 is made of elastic material such as rubber. The third auxiliary lip 126 is fixed to a radial outer side end of the frame radial portion 1212, for example, by vulcanization attachment, so that the third auxiliary lip 126 is located radially outside relative to the first auxiliary lip 124 and the second auxiliary lip 125. The third auxiliary lip 126, spaced apart from the first auxiliary lip 124 and the second auxiliary lip 125, extends from the frame 121 toward the radial portion 112 of the dustproof ring 11. But a free end of the third auxiliary lip 126 has an axial gap with the dustproof ring 11 so that they do not contact each other. Specifically, the free end of the third auxiliary lip 126 is configured to be bent toward the radial outer side.

With the configuration as described above, it is not likely that a liquid such as water will enter a space between the dustproof ring 11 and the seal assembly 12 through the labyrinth seal structure formed by the dustproof ring 11 and the second sealed portion 10s of the housing. This greatly reduces the probability of the dustproof lip being frozen and damaged as described in the background. In fact, even if a liquid such as water enters the labyrinth seal structure, it cannot enter the space between the dustproof ring 11 and the seal assembly 12. Instead, it may be frozen in the area forming the labyrinth seal structure between the dustproof ring 11 and the housing may be frozen, but this will not cause damage to the seal lip. Further, even if dust enters the space between the dustproof ring 11 and the seal assembly 12 through the labyrinth seal structure, it will be blocked by the auxiliary seal lip from entering the interior of the in-wheel electric motor drive system.

The specific embodiments of the in-wheel electric motor drive system according to the present application are described in detail above, and will be supplemented below.
i. The seal assembly 12 illustrated in the above specific embodiments is formed with one main lip 122 and three auxiliary lips 124, 125, 126, but the present application is not limited thereto. The seal assembly 12 comprising a different number of main lips and auxiliary lips may be provided as needed.
ii. In the above specific embodiments, as shown in FIG. 2, the radial outer side of the frame axial portion 1211 can be fixed with partial rubber structure by vulcanization attachment, and the seal assembly 12 is in contact with and fixed to the second sealed portion 10s of the housing by the partial rubber structure.

It can be understood that although the connection between each lip and the frame 121 is separately described, these lips are usually integrally attached to the frame 121. Therefore, these lips can be connected to each other.
iii. In the above specific embodiments, it is described that the outer peripheral surface of the dustproof ring 11 is substantially flush with that of the second sealed portion 10s, but the present application is not limited thereto. The outer peripheral surface of the dustproof ring 11 may be located radially inside that of the second sealed portion 10s.
iv. It can be understood that in order to prevent the dustproof ring 11 from colliding with the second sealed portion 10s due to vibration when the output shaft is in a rotating state, there must be a sufficient gap between the dustproof ring 11 and the second sealed portion 10s.
v. It can be understood that the labyrinth seal structure between the dustproof ring 11 and the second sealed portion 10s further provides better fire protection, and thus stops flames from entering.
vi. It can be understood that in present application, the space between the dustproof ring 11 and the seal assembly 12 is larger compared with the prior art, so more seal lips can be provided to improve the sealing performance.

### LIST OF REFERENCE NUMERALS

10 Housing body;
10c Notch;
10s Second sealed portion;
20 Housing cover;
30 Drive motor,
40 Rotor bracket;
50 Seal structure;
501 Dustproof ring;
502 Seal assembly;
502p Dustproof lip;
60 Radial bearing;
70 Planetary gear reducer;
80 Thrust bearing;
90 Output Shaft;
90s First sealed portion;
1 Seal structure;
11 Dustproof ring;
111 First axial portion;
112 Radial portion;
113 Second axial portion;
12 Seal assembly;
121 frame;
1211 frame axial portion;
1212 frame radial portion;
1122 Main lip;
123 Radial elastic member;
124 First auxiliary lip;
125 Second auxiliary lip;
126 Third auxiliary lip;
A Axial direction;
R Radial direction.

1. A seal structure for an in-wheel electric motor drive system, the seal structure being overall annular and used for forming a seal between a first sealed portion of an output shaft and a second sealed portion of a housing in the in-wheel electric motor drive system, wherein the first sealed portion and the second sealed portion are opposite to each other in a radial direction of the output shaft, and the second sealed portion is located radially outside the first sealed portion, the seal structure comprising a dustproof ring and a seal assembly, wherein:
the dustproof ring, which is used for being fixed to the first sealed portion, extends radially outwards, so that the dustproof ring extends beyond an inner peripheral surface of the second sealed portion;
and the dustproof ring is further formed with a structure that is bent toward the second sealed portion, so that the dustproof ring and the second sealed portion overlap with each other while being spaced apart in an axial direction and the radial direction of the output shaft, thereby forming a labyrinth seal structure;
the seal assembly, which is used for being fixed to the second sealed portion, is fully located between the first sealed portion and the second sealed portion; the seal assembly is provided with a plurality of lips extending toward the first sealed portion and/or the dustproof ring for blocking the communication between the labyrinth seal structure and the interior of the in-wheel electric motor drive system.

2. The seal structure for an in-wheel electric motor drive system according to claim 1, wherein the dustproof ring comprises a first axial portion, a radial portion and a second axial portion that form a single piece; the first axial portion extends in the axial direction and is used for being fixed to the first sealed portion, the radial portion extends in the radial direction and is connected to the first axial portion and the second axial portion, and the second axial portion extends from the radial portion toward the second sealed portion in the axial direction.

3. The seal structure for an in-wheel electric motor drive system according to claim 2, wherein a notch is formed on the radial outer side of the second sealed portion, and the second axial portion extends from the radial portion to the notch.

4. The seal structure for an in-wheel electric motor drive system according to claim 1, wherein an outer peripheral surface of the dustproof ring is substantially flush with that of the second sealed portion; or the outer peripheral surface of the dustproof ring is located radially inside that of the second sealed portion.

5. The seal structure for an in-wheel electric motor drive system according to claim 1, wherein the seal assembly comprises a frame, a main lip and a radial elastic member; the main lip, which is attached to the frame, extends toward and contacts the first sealed portion; and the radial elastic member is nested in the main lip from the radial outer side of the main lip to apply an elastic force that keeps the main lip in contact with the first sealed portion.

6. The seal structure for an in-wheel electric motor drive system according to claim 5, wherein at least a portion of the main lip extends obliquely in a direction away from the dustproof ring while extending toward the radial inner side.

7. The seal structure for an in-wheel electric motor drive system according to claim 5, wherein the seal structure further comprises a first auxiliary lip and a second auxiliary lip attached to the frame; the first auxiliary lip and the second auxiliary lip are arranged apart in the radial direction, the first auxiliary lip extending from the frame toward and keeping in contact with the dustproof ring,the second auxiliary lip extending from the frame toward and keeping in contact with the dustproof ring.

8. The seal structure for an in-wheel electric motor drive system according to claim 7, wherein at least a portion of the first auxiliary lip and of the second auxiliary lip extend obliquely toward the radial outer side while extending toward the dustproof ring .

9. The seal structure for an in-wheel electric motor drive system according to claim 5, wherein the seal assembly further comprises a third auxiliary lip located radially outside relative to the first auxiliary lip and the second auxiliary lip;
the third auxiliary lip, spaced apart from the first auxiliary lip and the second auxiliary lip, extends from the frame toward and has an axial gap with the dustproof ring.

10. The seal structure for an in-wheel electric motor drive system according to claim 9, wherein the third auxiliary lip is configured to have a structure that is bent toward the radial outer side.

11. An in-wheel electric motor drive system, comprising:
an output shaft;
a housing; and
the seal structure for an in-wheel electric motor drive system according to claim 1,
wherein the dustproof ring is fixed to the first sealed portion, and the seal assembly is fixed to the second sealed portion.

12. A seal structure for an in-wheel electric motor drive system, the seal structure comprising:
a dustproof ring; and
a seal assembly comprising a plurality of lips;
wherein the seal structure has an annular shape and is configured to form a seal between a first sealed portion of an output shaft and a second sealed portion of a housing in the in-wheel electric motor drive system, wherein the first sealed portion is opposite to the second sealed portion in a radial direction of the output shaft, and the second sealed portion is located radially outside the first sealed portion;
wherein the dustproof ring is configured to be fixed to the first sealed portion, wherein the dustproof ring extends radially outwards beyond an inner peripheral surface of the second sealed portion, wherein the dustproof ring is formed with a structure bent toward the second sealed portion to cause the dustproof ring and the second sealed portion to overlap and separated in an axial direction and the radial direction of the output shaft;
wherein the seal assembly is configured to be fixed to the second sealed portion and located between the first sealed portion and the second sealed portion, wherein the plurality of lips of the seal assembly extends toward at least one of the first sealed portion or the dustproof ring for blocking the communication between the seal structure and an interior of the in-wheel electric motor drive system.

13. The seal structure according to claim 12, wherein the dustproof ring comprises a first axial portion, a radial portion, and a second axial portion that form a single piece, wherein the first axial portion extends in the axial direction and configured for being fixed to the first sealed portion, wherein the radial portion extends in the radial direction and is connected to the first axial portion and the second axial portion, wherein the second axial portion extends from the radial portion toward the second sealed portion in the axial direction.

14. The seal structure according to claim 2, wherein a notch is formed on the radial outer side of the second sealed portion, and the second axial portion extends from the radial portion to the notch.

15. The seal structure according to claim 1, wherein an outer peripheral surface of the dustproof ring is flush with that of the second sealed portion; or the outer peripheral surface of the dustproof ring is located radially inside that of the second sealed portion.

16. The seal structure according to claim 1, wherein the seal assembly comprises a frame, a main lip and a radial elastic member, wherein the main lip is attached to the frame and extends toward and contacts the first sealed portion, wherein the radial elastic member is nested in the main lip from the radial outer side of the main lip to apply an elastic force that keeps the main lip in contact with the first sealed portion.

17. The seal structure according to claim 5, wherein at least a portion of the main lip extends obliquely in a direction away from the dustproof ring while extending toward the radial inner side.

18. The seal structure according to claim 5, wherein the seal structure further comprises a first auxiliary lip and a second auxiliary lip attached to the frame, wherein the first auxiliary lip and the second auxiliary lip are arranged apart in the radial direction, wherein the first auxiliary lip extends from the frame toward the dustproof ring, wherein the second auxiliary lip extends from the frame toward the dustproof ring.

19. The seal structure for an in-wheel electric motor drive system according to claim 18, wherein at least a portion of the first auxiliary lip and the second auxiliary lip extend obliquely toward the radial outer side while extending toward the dustproof ring.

20. An in-wheel electric motor drive system comprising:
an output shaft;
a housing; and
a seal structure, wherein the seal structure comprises:
a dustproof ring; and
a seal assembly comprising a plurality of lips;
wherein the seal structure has an annular shape and is configured to form a seal between a first sealed portion of the output shaft and a second sealed portion of the housing, wherein the first sealed portion is opposite to the second sealed portion in a radial direction of the output shaft, and the second sealed portion is located radially outside the first sealed portion;
wherein the dustproof ring is configured to be fixed to the first sealed portion, wherein the dustproof ring extends radially outwards beyond an inner peripheral surface of the second sealed portion, wherein the dustproof ring is formed with a structure bent toward the second sealed portion to cause the dustproof ring and the second sealed portion to overlap and separated in an axial direction and the radial direction of the output shaft;
wherein the seal assembly is configured to be fixed to the second sealed portion and located between the first sealed portion and the second sealed portion, wherein the plurality of lips of the seal assembly extends toward at least one of the first sealed portion or the dustproof ring for blocking the communication between the seal structure and an interior of the in-wheel electric motor drive system.
